(19) United States
(12) Patent Application Publication
(10) Pub. No.: US 2016/0034945 A1
(43) Pub. Date: Feb. 4, 2016

(54) SLICE COMPETITOR IMPRESSION PENETRATION BY USER TYPE AND AD FORMAT

(71) Applicant: Google Inc., Mountain View, CA (US)

(72) Inventors: Justin Lewis, Marina del Rey, CA (US); Ruxandra Georgiana Paun, Santa Monica, CA (US)

(21) Appl. No.: 14/482,768

(22) Filed: Sep. 10, 2014

Related U.S. Application Data
(60) Provisional application No. 62/030,406, filed on Jul. 29, 2014.

(51) Int. Cl. G06Q 30/02

(52) U.S. Cl. CPC G06Q 30/0242; G06Q 30/0256

(57) ABSTRACT

Systems and methods for providing competitive analysis are provided. A data processing system can receive from a first content provider a selection of a value for a targeting criteria. A second content provider associated with the first content provider is determined. A content format served by the second content provider is determined based on the selected value for the targeting criteria, over a predetermined period of time. The data associated with the second content provider and the content format is provided to the first content provider.

### CROSS-REFERENCE TO RELATED PATENT APPLICATIONS

This application claims the benefit of priority to U.S. Provisional Application No. 62/030,406, filed Jul. 29, 2014, which is hereby incorporated herein by reference in its entirety.

### BACKGROUND

Internet users explore online content by browsing various websites. Some users are interested in purchasing products or services over the Internet. For example, a user may search for a product that they are interested in by entering appropriate search terms into an Internet search engine. The user then explores a listing of webpages provided in the search results. The search results may include paid content items provided by content providers who would like to attract users to their Internet properties. Paid content items may also be displayed to users on other platforms including social media platforms, media streaming platforms, and others. The content providers want to compare their online presence with their competitors. Better understanding of the competitive landscape would allow the content providers to reach the right users.

### SUMMARY

At least one aspect is directed to a method. The method includes receiving, from a first content provider, a selection of a value for a targeting criteria. The method further includes determining a second content provider associated with the first content provider. The method further includes determining a content format served by the second content provider based on the selected value for the targeting criteria, over a predetermined period of time. The method further includes providing data associated with the second content provider and the content format to the first content provider.

At least one aspect is directed to a system. The system includes: one or more data processors; and one or more storage devices storing instructions that, when executed by the one or more data processors, cause the one or more data processors to perform operations comprising: receiving, from a first content provider, a selection of a value for a targeting criteria; determining a second content provider associated with the first content provider; determining a content format served by the second content provider based on the selected value for the targeting criteria, over a predetermined period of time; and providing data associated with the second content provider and the content format to the first content provider.

At least one aspect is directed to a computer-readable storage medium having instructions to provide information via a computer network. The instructions comprising instructions to: receive, from a first content provider, a selection of a value for a targeting criteria; determine a second content provider associated with the first content provider; determine a content format served by the second content provider based on the selected value for the targeting criteria, over a predetermined period of time; and provide data associated with the second content provider and the content format to the first content provider.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system, in an accordance with a described implementation;

FIGS. 2A-B illustrate user interfaces enabling content providers to look at keyword categories targeted by competitors, in an accordance with a described implementation;

FIG. 3 illustrates a user interface allowing a content provider to select targeting criteria and view competitor content formats and statistics, in an accordance with a described implementation;

FIG. 4 is a flow diagram of a process for determining and providing data determined based on targeting criteria selection; and

FIG. 5 is a block diagram illustrating a general architecture for a computer system that may be employed to implement various elements of the systems and methods described herein, in accordance with an implementation.

Like reference numbers and designations in the various drawings indicate like elements.

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concept.

According to various embodiments disclosed herein, user interfaces are provided that allow content providers to select a particular set of users in order to identify keyword categories that their competitors are investing in and receive keyword category recommendations. The content providers are provided with recommended keyword targeting results based on the selected set of users. In particular, the content provider may select values for one or more user categories including, but not limited to, age, gender, income level, location, time of day, device, user browsing history, user interest, user endorsement, user cluster inclusion, and user set inclusion. Based on the user category selections and data stored for the various content providers, the content provider is provided with data regarding ways in which their competitors are reaching their target audience in ways that the advertiser is not yet. The provided data may include aggregate statistics (e.g., number of impressions received per week) regarding user traffic.

In some embodiments, the content provider may be provided with information regarding content formats that the competitors are using to reach their audience. The content formats may include, but not be limited to, search content, display content, in-stream content, interactive content, content with phone numbers, content with social annotations, device specific content formats, etc. Access to content format information may advantageously encourage content providers to use a greater variety of content formats. The content formats may be advertisement formats (e.g., search advertisements, display advertisements, in-stream advertisements, etc.).

The data regarding competitive interests can be associated with various platforms including, but not limited to, an online advertisement platform, social media platform, online video streaming platform, online news aggregator platform, social network platform, or other online platform where competitors may compete with a customer for market share, impressions, clicks, conversions, or access in general.

In some embodiments, a set of competitors for each content provider may be identified (e.g., based on content providers sharing a similar set of purchased content source impressions) by a data processing system on an intermittent basis, as triggered by a content provider, on a scheduled basis, etc. The data processing system may count and categorize the number of impressions generated for each combination of display location (keyword, domain or channel) and user metadata. These categorized counts may be stored in a data storage (in the data processing system or in a data storage accessible by the data processing system) to be served to the content providers. In one embodiment, the process of serving these competitive analyses as keyword and ad format suggestions to users is accomplished by the data processing system retrieving the categorized counts from the database, organizing them, and serving them to a client device for rendering. Alternatively, the client device organizes the data instead of the data processing system.

A content provider may be an “online advertiser” or “internet advertiser”. The “online advertiser” or “Internet advertiser” refers to a business (typically represented by a domain name, a web address, URL, or a smartphone app) that uses the Internet to deliver promotional marketing messages to consumers. To improve advertisement efficiency, an online advertiser desires to display online advertisements on an online space that is likely visited by potential customers. Online advertisers that target similar consumer groups, accordingly, are likely to compete with each other for the same online space. Such online advertisers, therefore, belong to the same “advertising category” and are “advertisement competitors.”

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

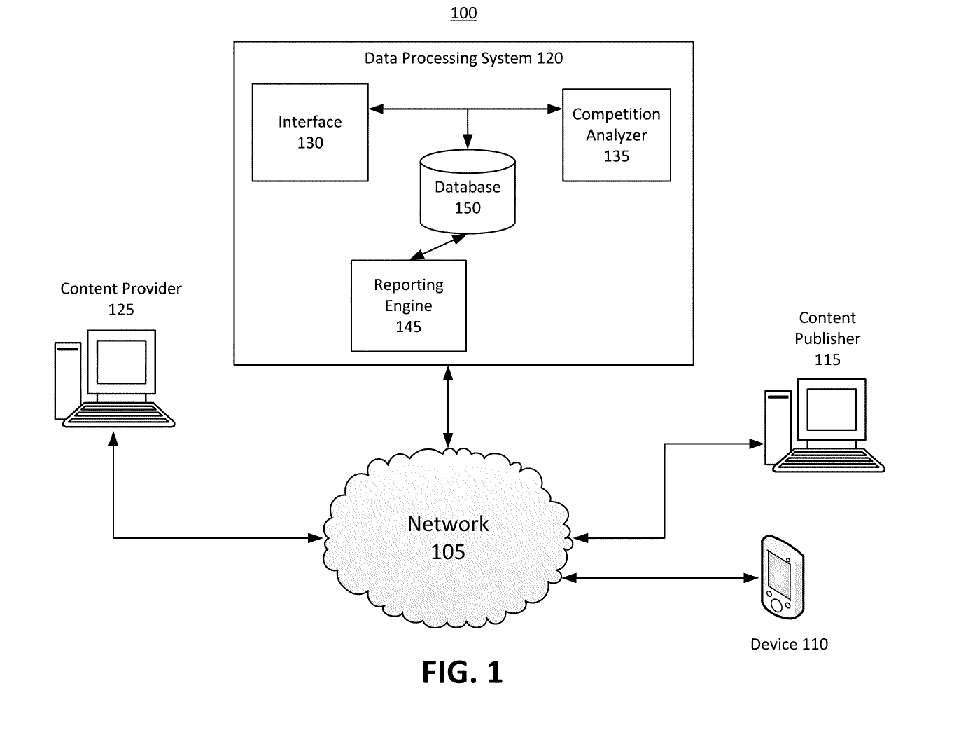

FIG. 1 illustrates one implementation of a system 100 for selecting and serving content, and performing competition analysis, via a computer network such as network 105. The system 100 and its components, such as a data processing system 120, may include hardware elements, such as one or more processors, logic devices, or circuits. The network 105 can include computer networks such as the Internet, local, wide, metro, data, or other area networks, intranets, satellite networks, combinations thereof, and other communication networks such as voice or data mobile telephone networks. The network 105 can be used to access information resources such as web pages, web sites, domain names, or uniform resource locators that can be displayed on at least one device 110, such as a laptop, desktop, tablet, personal digital assistant, smart phone, mobile computing devices, mobile telecommunication device, wearable computing device, or portable computer. In one implementation, via the network 105 a user of the device 110 can access web pages provided by at least one content publisher 115 (e.g., a web site operator). In this implementation, a web browser of the device 110 can access a web server of the content publisher 115 to retrieve a web page for display on a monitor of the device 110. The content publisher 115 generally includes an entity that operates the web page. In one implementation, the content publisher 115 includes at least one web page server that communicates with the network 105 to make the web page available to the device 110.

Although FIG. 1 shows a network 105 between the device(s) 110, data processing system 120, content provider 125, and content publisher 115, the device(s) 110, content publisher 115, content provider 125 and data processing system 120 may be on the same network 105. The network 105 can be a local-area network (LAN), such as a company Intranet, a metropolitan area network (MAN), or a wide area network (WAN), such as the Internet or the World Wide Web. In some implementations, there are multiple networks 105 between the devices 110 and the data processing system 120, content provider 125, and content publisher 115. In one of these implementations, the network 105 may be a public network, a private network, or may include combinations of public and private networks.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, the network 105 may include a wireless link, such as an infrared channel or satellite band. The topology of the network 105 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some implementations, different types of data may be transmitted via different protocols. In other implementations, the same types of data may be transmitted via different protocols.

The system 100 can include at least one data processing system 120. The data processing system 120 can include at least one logic device such as a computing device having a processor to communicate via the network 105 with the device 110, the content publisher 115, and at least one content provider 125. The data processing system 120 can include at least one server. In one implementation, the data processing system 120 can include a plurality of servers located in at least one data center. In some implementations, the data processing system 120 may include multiple, logically-grouped servers and facilitate distributed computing techniques. In one of these implementations, the logical group of servers may be referred to as a server farm or a machine farm. In another of these implementations, the servers may be geographically dispersed. In other implementations, a machine farm may be administered as a single entity. In still other implementations, the machine farm includes a plurality of machine farms. The servers within each machine farm can be heterogeneous (i.e., one or more of the servers or machines can operate according to one type of operating system platform).

In one implementation, servers in the machine farm may be stored in high-density rack systems, along with associated storage systems, and located in an enterprise data center. In this implementation, consolidating the servers in this way may improve system manageability, data security, the physical security of the system, and system performance by locating servers and high performance storage systems on localized high performance networks. Centralizing the servers and storage systems and coupling them with advanced system management tools allows more efficient use of server resources.

The data processing system 120, the content provider 125, the content publisher 115, and device 110 may be deployed or executed on any type of client or server, or any type and form of computing device, such as a computer, network device or appliance capable of communicating on any type and form of network and performing the operations described herein.

The data processing system 120 can include, e.g., an online advertisement server, social media server, online video streaming system, online news aggregation system, social networking system, or other online platform where competitors may compete with a customer for market share, impressions, clicks, conversions, or access in general. In one illustrative implementation, the data processing system 120 includes a content placement system having at least one server. The data processing system 120 can also include at least one interface 130, at least one competition analyzer 135, at least one reporting engine 145, and at least one database 150. In one implementation, the data processing system 120 can include a machine learning module such as a logistic regression module or decision tree module. The interface 130, the competition analyzer 135, the reporting engine 145, and machine learning module can each include at least one processing unit or other logic device such as programmable logic array engine, or module configured to communicate with the database 150. The interface 130, the competition analyzer 135, the reporting engine 145, and machine learning module can be separate components, a single component, or part of the data processing system 120.

In some implementations, the data processing system 120 obtains anonymous computer network activity information associated with a plurality of devices 110. A user of a device 110 can affirmatively authorize the data processing system 120 to obtain network activity information corresponding to the user's device 110. In one implementation, the data processing system 120 can prompt the user of the device 110 for consent to obtain one or more types of network activity information, such as geographic location information. The identity of the user of the device 110 can remain anonymous and the device 110 may be associated with a unique identifier (e.g., a cookie).

For situations in which the systems discussed here collect personal information about users (including, e.g., customers or competitors), or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). In one implementation, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

In one implementation, the data processing system 120 receives content or content items from a content provider 125, such as a customer, commercial entity, online retailer, business, advertiser, advertisement customer, competitor, individual or any entity that wants to provide content for display on a device 110 via the computer network 105. The content or content items may include, e.g., text, characters, symbols, images, video, audio, or multimedia content. In one implementation, a content item may include an online advertisement, article, promotion, coupon, or product description.

In some implementations, the data processing system 120 includes an interface 130 designed and constructed to receive a request for content. The interface 130 may be configured to receive a request for content via the network 105. The interface 130 can convey information between one or more components of the data processing system or network 105. The interface 130 can be configured to communicate with applications executing on the content provider device 125, the content publisher device 115, or the device 110. In some implementations, the interface 130 may be configured to convey information via an Application Program Interface (“API”). In some implementations, an application executing on a mobile device may communicate with data processing system 120 via an API configured to communicate with the interface 130.

In some implementations, the data processing system 120 may select a content item (e.g., an advertisement) based on a search query input via device 110. The data processing system 120 may parse, analyze, match, or otherwise process one or more search terms of the search query to identify one or more candidate content items associated with the search query. In illustrative implementations, the data processing system 120 may receive a search query comprising the term “pizza”. The data processing system 120 may then parse a data structure to identify content items related to pizza, such as advertisements or coupons for pizza restaurants. These content items may be provided by one or more content providers 125. In some implementations, the data processing system 120 may select one or more content items to provide for display on the device based on, e.g., an online auction, advertisement score, keyword score, location, or other criteria. In the online auction, content providers 125 may bid on keywords or other content selection criteria (e.g., location, demographics, topics, etc.). The bids may be associated with a content item. The data processing system may select the content item for display based, at least in part, on the bids associated with the content item (e.g., the content item with the highest bid, with all other factor being equal, may be selected for display on the device 110). In other illustrative implementations, the search query may include a query for a video clip (e.g., in the online media streaming system), a news article (e.g., in the online news aggregation system), or a friend (e.g., in the social networking system).

The data processing system 120 may provide the content item to the web page for display in response to receiving a request for content from a computing device such as, e.g., device 110. In some implementations, the data processing system 120 receives the request via an application executing on the device 110. In some implementations, a mobile application executing on a mobile device (e.g., smart phone or tablet) may make a request for content. In some implementations, a web page may request content from the data processing system 120 responsive to a user of a device 110 visiting the web page. In some implementations, the request for content may be for an online video streaming platform, a social media platform, a social network, computer game, video game, electronic document, banner, etc. In an illustrative implementation, the request for content may be for an item of content to be inserted in a video clip, overlaid on a video clip, displayed in a popup window associated with a video clip, or otherwise displayed before, during or after the video clip. In some implementations, the data processing system 120 may receive a request for content via a search engine and responsive to a user of a device 110 entering a search query.

In one example, the data processing system 120 can receive a search query for “coffee shops” via a device 110. The search query may be input into a search engine accessed via the device 110. The data processing system 120 can receive a request for a content item for display on the device 110. The data processing system 120 may further receive information related to the search query (e.g., keywords, terms, topics) or the search query itself. In some implementations, the request for content items may be a request for content items that are provided for display on a device alongside search results. In some implementations, the request for content items may be a request for content items that are to be displayed on a web page of a web publisher.

In some implementations, the request for content includes information that can facilitate content selection. In some implementations, the data processing system 120 may request information from the device 110 to facilitate identifying content or selecting content. The data processing system 120 may request or obtain information responsive to receiving a request for content from the device 110. The information may include information about displaying the content on the device 110 (e.g., a content slot size or position) or available resources of device 110 to display or otherwise manipulate the content.

In some implementations, the interface 130 receives information associated with a search query which was input into a device. The information may include keywords, terms, concepts of the search query, or the search query itself. In some implementations, the interface 130 receives the information related to the search query via network 105.

Responsive to a request for content from a content publisher 115 (e.g., a search engine provider, web page operator), the data processing system 120 provides a content item for display (or other presentation) with a web page on a device 110. A user of the device 110 may view the content item (e.g., an impression) or may click on or select the content item (e.g., a click). In one implementation, an indication of interest in the content item may include a click, selection, mouse over, finger gesture, shake motion, voice command, tap, or another indication that indicates interest in the content item. In some implementations, the indication of user interaction may include the user using the content item (e.g., a coupon) to make a purchase at a redemption location.

In some implementations, the data processing system 120 can be designed and constructed to provide information to a content provider (e.g., an advertiser of an online advertisement platform, an advertiser of an online video streaming platform, social media platform, social network, news aggregation site, etc.) about their competitors. The data processing system 120 may include a competition analyzer 135 which may identify competitors for an online advertiser or a third-party user of the data processing system 120 that may be associated with the online advertiser or content provider 125.

The competition analyzer 135 can be configured to apply various techniques to identify competitors of the customer. In one implementation, the competition analyzer 135 identifies a set of competitors for each content provider (i.e., for each advertiser) based on sharing a similar set of purchased content source impressions. The set of competitors may be identified using user clustering mechanisms. These clusters may be generated off the set of content sources selected. The clusters may be generated based on impression counts in each content source. The set of purchased impressions may be limited to the content source that the competitor manually or specifically selected to advertise on, and/or may include content sources which were targeted based on broader criteria (e.g., an automated categorical or demographic driven system).

After the competitors are identified, the competition analyzer may count and categorize the number of impressions (or clicks or another statistic) generated for each combination of display location (keyword, domain or channel) and user metadata. The categorized counts are stored in the database 150 (or another data storage). The reporting engine 145 may serve these competitive analyses (e.g., as keyword or content format suggestions). The reporting engine may retrieve the categorized counts from the database 150, organize the retrieved data and transmit to the client device 110 for rendering. The client device 110 may perform a varying level of organization on the data instead of the reporting engine 145. For example, the raw values for each cell may be passed down to the device 110, which in turn handles sorting, reorganizing, or filtering the elements for the user (i.e., advertiser).

The competition analyzer 135 may identify competitors in real-time, a periodic basis, or upon request. In some implementations, the competition analyzer 135 may identify competitors responsive to receiving data about potential competitors or responsive to the customer taking an action (or receiving information about the action).

The reporting engine 145 may provide one or more reports having data regarding competitor usage of various content formats, user traffic statistics (e.g., impressions, clicks), a listing of top competitors, etc. The report(s) may be provided upon request from a content provider using one or more user interfaces provided by the data processing system 120. In other implementations, the reports may be sent to the content providers as notifications (e.g., via email, alerts in the data processing system 120, etc.).

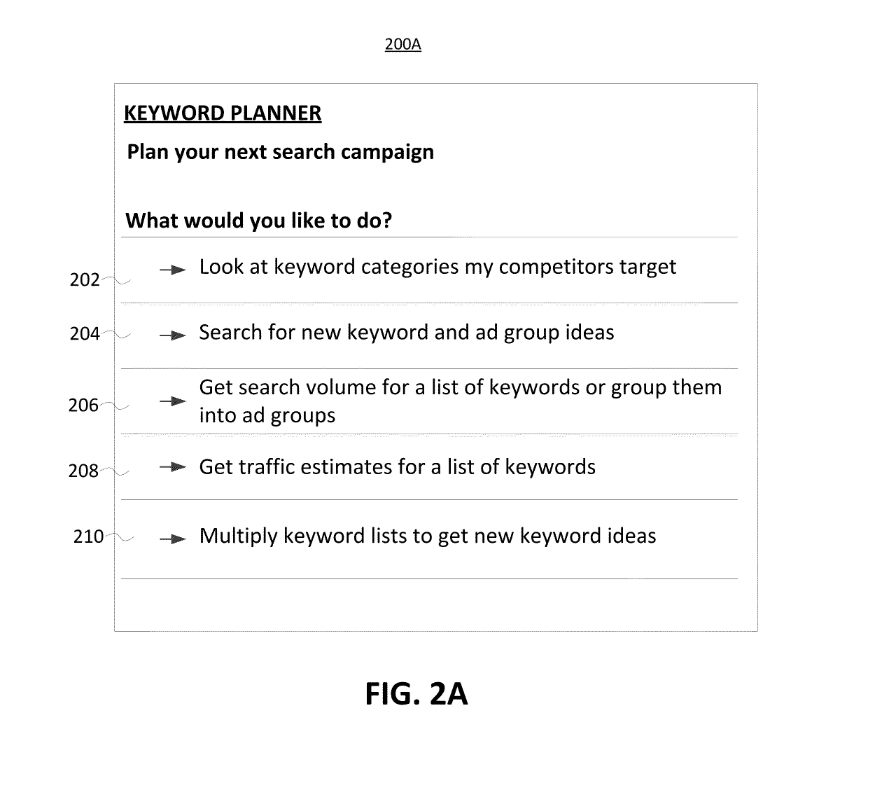

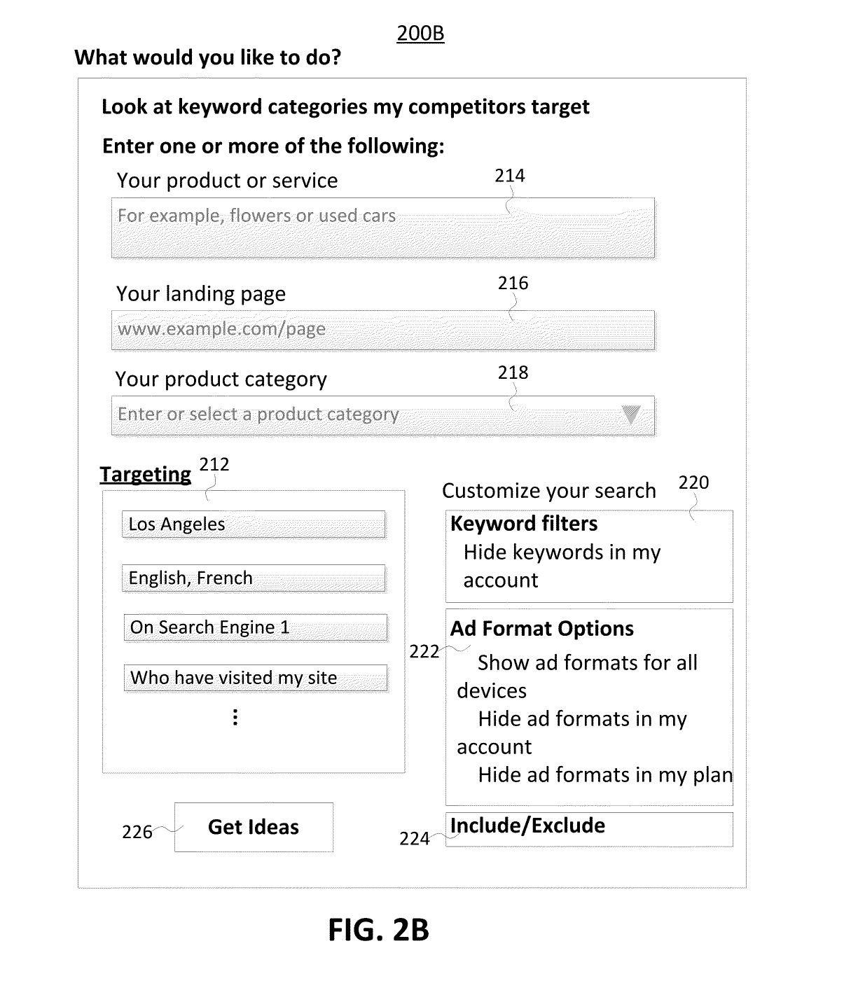

FIGS. 2A-B illustrates exemplary user interfaces allowing content providers to obtain information regarding their competitors. A user interface 200A offers a content provider five selections (202, 204, 206, 208, and 210), each of which may help the content provider with creating new advertising campaigns or improving their existing advertising campaigns (e.g., by using new content formats, utilizing new categories of keywords, etc.).

As shown in the user interface 200A, the five selections include “look at keyword categories my competitors target”, “search for new keyword and ad group ideas”, “get search volume for a list of keywords or group them into ad groups”, “get traffic estimates for a list of keywords”, and “multiply keyword lists to get new keyword ideas”. These selections may be hyperlinks or links, that trigger re-direction of the web-browser or application to another user interface related to the user selected selection. For example, if the user clicks on or otherwise selects the selection 204, a user interface or webpage is shown to the user that allows the user to search for new keywords and explore suggested ad group ideas. When the user clicks on or otherwise selects the selection 206, a user interface or webpage is shown to the user that displays to the user search volume for a list of keywords or groups them into ad groups. When the user clicks on or otherwise selects the selection 208, a user interface or webpage is shown to the user that provides traffic estimates for a list of keywords. When the user clicks on or otherwise selects the selection 210, a user interface or a webpage is shown to the user that provides new keyword ideas to the user.

When the user clicks on or otherwise selects a selection 202 (“Look at keyword categories my competitors target”), a user interface 200B shown in FIG. 2B is displayed to the user. The user interface 200B allows the user to provide one or more of: product or service, landing page, product category. The user interface 200B further allows the user to select one or more of targeting criteria 212. As shown, the targeting criteria selections include persons who have visited the website, who have searched for this particular content on the search enginel, who are located in Los Angeles, and who speak English or French.

Although the user only selected values for user categories including location, language, user interest, and user browsing history, other targeting criteria may be selected in addition to/or in place of the selections shown in user interface 200B. The user may select values for any combination of the following user categories: age, gender, income level, location, time of day, device, user browsing history (e.g., has the user visited the website before), user interest (e.g., has the user visited, not skipped, or searched for this kind of content before), user endorsement (e.g., has the user publicly endorsed this particular content or that kind of content before), user cluster inclusion (e.g., does the user fall into the same bucket of users who are current active customers (based on browse, search, watch, endorsement history), user set inclusion (e.g., does the user fit in a set of users that matches some other criteria such as retargeting).

Based on the selections made in the targeting criteria section 212 and areas 214, 216, and 218, the user (e.g., the content provider) may click on a button 226 to view suggestions or ideas regarding keyword categories that are targeted by the competitors.

The user can further customize searching using customization areas 220, 222, and 224. For example, using the customization area 220 may allow the user to hide keyword in their account. The area 222 allows the user further customize the information that they can view regarding ad formats. In particular, the area 222 allows the user to select the option of showing ad formats for all devices, hide ad formats in the user's account, and/or hide ad formats in their plan. The area 224 allows the user to include or exclude particular keywords from the search.

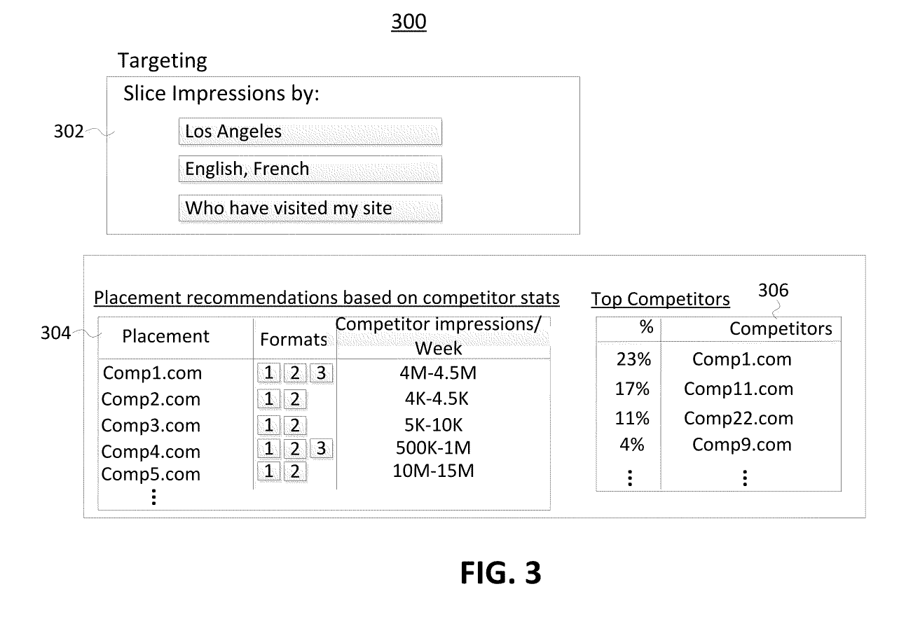

FIG. 3 illustrates a user interface that provides placement recommendations based on competitor impressions including content formats utilized by competitors based on targeting criteria selected by the user. As shown, the user selects targeting criteria in an area 302. The selections reflect the user's target audience, which in this example is persons located in Los Angeles, who have visited their web site, and who speak English or French.

Based on these targeting selections, placement recommendations area 304 provides a listing of placements, which are competitor websites, along with content formats used by each of the shown placements, and the competitor's impressions per week. For example, as shown, the first entry in the area 304 is a placement of Comp1.com, with this competitor receiving between 4 million to 4.5 million impressions per week. As further shown, this competitor utilized three different content formats (e.g., content formats). The ad formats can include search ads, display ads, in-stream ads, interactive ads, ads with phone numbers, ads with social annotations, device specific ad formats (such as those for in app purchases). Thus, the user can types of content formats that are utilized by various competitors and how many impressions per week each of those competitors are receiving. The top competitors areas 306 displays a list of top competitors including the percentage of the impressions that each of the competitors are receiving.

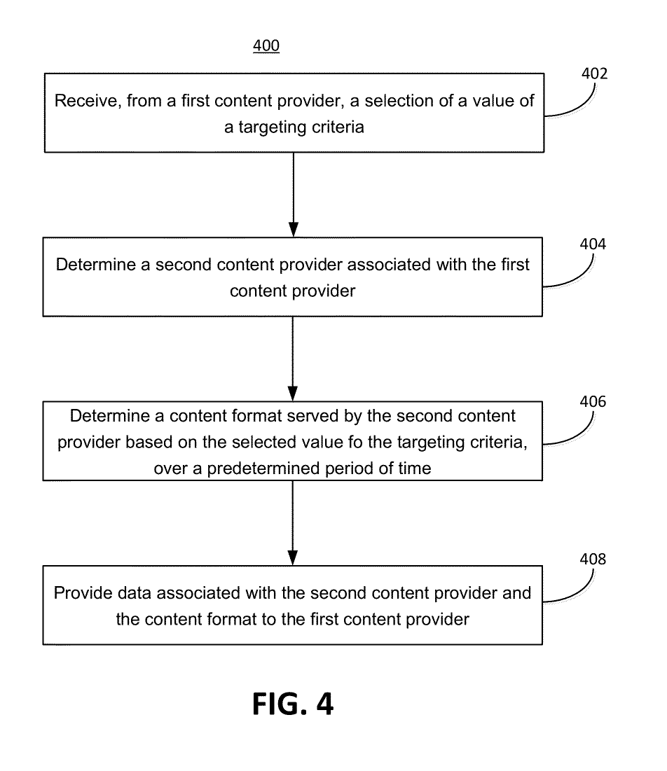

FIG. 4 is a flow diagram of a process 400 for determining a content item with dynamically selected images, in accordance with an illustrative embodiment. The process 400 can be implemented on a computing device (e.g., a server). In one embodiment, the process 400 is encoded on a computer-readable medium that contains instructions that, when executed by the computing device, cause the computing device to perform operations of the process 400.

At block 402, a selection of a value for a targeting criteria is received from a first content provider. For example, the first content provider may select value for the targeting criteria using the user interface 300 or another user interface. The targeting criteria can be any one of the following: age, gender, income level, location, time of day, device, user browsing history, user interest, user endorsement, user cluster inclusion, user set inclusion, and others. The user may select values for any number of these targeting criteria.

A second content provider is determined (block 404) associated with the first content provider. In some implementations, the second content provider is determined by retrieving data associated with the first content provider from a data storage, which includes content providers (such as second content provider) who are associated with the first content provider. In these implementations, one or more content providers (including the second content provider) are identified for the first content provider (e.g., on an intermittent basis, on scheduled basis, when triggered by a user, etc.) based on sharing a similar set of purchased content source impressions. This process may be accomplished using one or more clustering mechanisms.

These clusters may be generated from the set of content sources selected, or may take into account impression counts in each content source. The set of purchased impressions may be limited to the content source that the content provider manually or specifically selected to advertise on or it may include content sources which were targeted based on broader criteria (e.g., an automated categorical or demographic driven system).

The number of impressions (or clicks) generated for each combination of display location (e.g., keyword, domain, or channel) and user metadata may be counted and categorized. In turn, these categorized counts may be stored in a data storage to be served to the first content provider. In these embodiments, at block 404, the second content provider is determined by retrieving records associated with the first content provider from the data storage.

For example, the second content provider may be a competitor of the first content provider. In other implementations, the second competitor may be determined based on sharing a similar set of purchased content source impressions.

A content format serviced by the second content provider is determined (block 406) based on the selected value for the targeting criteria over a predetermined period of time. The content format may be an advertisement format. The advertisement formats can include search ads, display ads, in-stream ads, interactive ads, ads with phone numbers, ads with social annotations, device specific ad formats, etc. The content format may be determined by retrieving data from the data storage.

The data associated with the second content provider and the content format is provided (block 408) to the first content provider. The placement recommendations area 304 illustrates providing the data associated with content providers and content formats. The data may include a total number (or a range) of impressions (clicks, or another performance statistic) received by each content provider (e.g., 500,000) over a predetermined period of time (e.g., per week). Thus, the first content provider is enabled to specify a target audience, and identify which competitors are reaching their target audience in way that they are not yet. For example, a competitor might be reaching the first content provider's target audience (as identified by targeting criteria) as indicated by the number of impressions received by that competitor and the ad formats that are utilized by that competitor. As a result, the first content provider may wish to add new ad format to their advertisement campaigns.

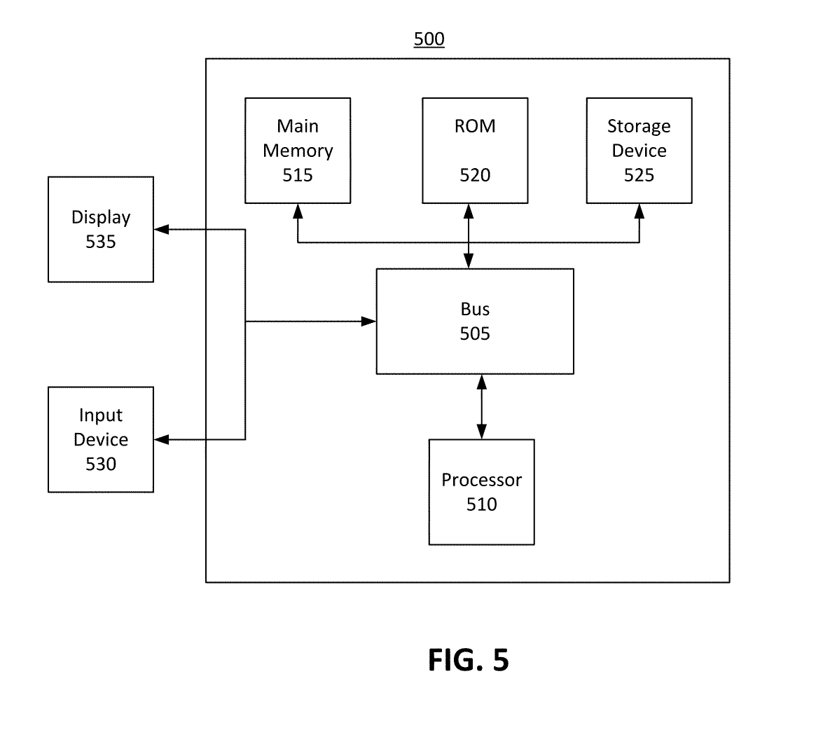

FIG. 5 is a block diagram of a computing system 500 in accordance with an illustrative implementation. The computing system or computing device 500 can be used to implement the system 100, content provider 125, device 110, content publisher 115, data processing system 120, interface 130, notification engine 145, and machine learning module. The computing system 500 includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to effect illustrative implementations. Thus, implementations are not limited to any specific combination of hardware circuitry and software.

Although a computing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “data processing apparatus” or “computing device” encompasses various apparatuses, devices, and machines for processing data, including without limitation a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

Processors suitable for the execution of a computer program include, without limitation, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including without limitation semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; in most implementations, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the notifications can be associated with any program capable of generating and providing notifications for display. Although the examples provided herein relate to an advertising program, the systems and methods described herein can be applied to any program in any vertical in which notifications generated by a plurality of different notification generation systems are provided for display on a single user interface. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method comprising:
receiving, from a first content provider, a description of an offer for sale by the first content provider;
receiving, from the first content provider, a selection of a value for a targeting criteria;
determining a second content provider associated with the first content provider based on the description of the offer;
determining a content format served by the second content provider based on the description of the offer and the selected value for the targeting criteria; and
providing data associated with the second content provider and the content format to the first content provider.

2. The method of claim 1, further comprising:
determining a keyword associated with an offer for sale by the second content provider; and
providing the keyword to the first content provider.

3. The method of claim 2, further comprising: determining a second content format served by the second content provider based on the keyword.

4. The method of claim 1, further comprising:
determining, for the second content provider, data associated with impressions received on content served by the second content provider; and
providing the data associated with impressions to the first content provider.

5. The method of claim 4, further comprising:
selecting a subset of the impressions received based on the data associated with the impressions received;
determining a keyword associated with the subset of the impressions received; and
providing the keyword to the first content provider.

6. The method of claim 4, the data associated with the impressions received comprising one or more of a geographic location, a time of day, an age, a gender, and an income level associated with each impression.

7. The method of claim 1, the targeting criteria comprising one or more of a geographic location, a time of day, an age, a gender, and an income level.

8. A system comprising:
one or more data processors; and
one or more storage devices storing instructions that, when executed by the one or more data processors, cause the one or more data processors to perform operations comprising:
receiving, from a first content provider, a description of an offer for sale by the first content provider;
receiving, from the first content provider, a selection of a value for a targeting criteria;
determining a second content provider associated with the first content provider based on the description of the offer;
determining a content format served by the second content provider based on the description of the offer and the selected value for the targeting criteria; and
providing data associated with the second content provider and the content format to the first content provider.

9. The system of claim 8, the operations further comprising:
determining a keyword associated with an offer for sale by the second content provider; and
providing the keyword to the first content provider.

10. The system of claim 9, further comprising: determining a second content format served by the second content provider based on the keyword.

11. The system of claim 8, the operations further comprising:
determining, for the second content provider, data associated with impressions received on content served by the second content provider; and
providing the data associated with impressions to the first content provider.

12. The system of claim 11, the operations further comprising:
selecting a subset of the impressions received based on the data associated with the impressions received;
determining a keyword associated with the subset of the impressions received; and
providing the keyword to the first content provider.

13. The system of claim 11, the data associated with the impressions received comprising one or more of a geographic location, a time of day, an age, a gender, and an income level associated with each impression.

14. The system of claim 9, the targeting criteria comprising one or more of a geographic location, a time of day, an age, a gender, and an income level.

15. A computer-readable storage medium having instructions to provide information via a computer network, the instructions comprising instructions to:
receive, from a first content provider, a description of an offer for sale by the first content provider;
receive, from the first content provider, a selection of a value for a targeting criteria;
determine a second content provider associated with the first content provider based on the description of the offer;
determine a content format served by the second content provider based on the description of the offer and the selected value for the targeting criteria; and
provide data associated with the second content provider and the content format to the first content provider.

16. The computer-readable storage medium of claim 15, further comprising instructions to:
determine a keyword associated with an offer for sale by the second content provider; and
provide the keyword to the first content provider.

17. The computer-readable storage medium of claim 16, further comprising instructions to:
determine a second content format served by the second content provider based on the keyword.

18. The computer-readable storage medium of claim 15, further comprising instructions to:
determine, for the second content provider, data associated with impressions received on content served by the second content provider; and
provide the data associated with impressions to the first content provider.

19. The computer-readable storage medium of claim 15, further comprising instructions to:
select a subset of the impressions received based on the data associated with the impressions received;
determine a keyword associated with the subset of the impressions received; and
provide they keyword to the first content provider.

20. The computer-readable storage medium of claim 15, the data associated with the impressions received comprising one or more of a geographic location, a time of day, an age, a gender, and an income level associated with each impression.
